(19) United States
(12) Patent Application Publication
(10) Pub. No.: US 2009/0135783 A1
(43) Pub. Date: May 28, 2009

(54) FMIPv6 Intergration with Wimax

(76) Inventors: Mohamed Khalil, Murphy, TX (US); Haseeb Akhtar, Garland, TX (US)

Correspondence Address: Hemingway & Hansen, LLP, 1717 Main Street, Comerica Bank Tower- Suite 2500, Dallas, TX, 75201, US

(21) Appl. No.: 12/083,422

(22) PCT Filed: Jul. 20, 2006
(86) PCT No.: PCT/US2006/028258

§ 371 Date: Apr. 11, 2008

Related U.S. Application Data
(60) Provisional application No. 60/700,863, filed on Jul. 20, 2005.

(51) Int. Cl. H04W 36/00

(52) U.S. Cl. 370/331

(57) ABSTRACT

A fast handover protocol standard implemented on WiMAX networks integrating Internet protocol fast handover messaging. A standard for performing handover in four scenarios is offered with an embodiment for the message flow to perform the handover. The four scenarios include a mobile subscriber station initiated predictive hand-off, a network initiated predictive hand-off, a mobile subscriber station initiated reactive hand-off, and a network initiated reactive hand-off. In general, Internet Protocol control messages for fast hand-off or handover are used on the WiMAX network. Fast binding and fast binding acknowledge messages are exchanged between two WiMAX access networks in all four scenarios. Other messages used include hand-off initiate, hand-off acknowledge, proxy router advertisement, session information request, and release resources Internet Protocol control messages are integrated with WIMAX control messages to perform the fast handover protocol.

### RELATED APPLICATION DATA

This application is related to U.S. Provisional Patent Application Ser. No. 60/700,863 filed on Jul. 20, 2005, and priority is claimed for these earlier filings under 35 U.S.C. §120. The Provisional Patent Application is also incorporated by reference into this PCT patent application.

### TECHNICAL FIELD OF THE INVENTION

A handover protocol for integrating the Fast Mobile IPv6 (FMIPv6) protocol into WiMAX access protocol.

### BACKGROUND OF THE INVENTION

The Internet, like so many other high tech developments, grew from research originally performed by the United States Department of Defense. In the 1960s, the military had accumulated a large collection of incompatible computer networks. Computers on these different networks could not communicate with other computers across their network boundaries.

In the 1960s, the Defense Department wanted to develop a communication system that would permit communication between these different computer networks. Recognizing that a single, centralized communication system would be vulnerable to attacks or sabotage, the Defense Department required that the communication system be decentralized with no critical services concentrated in vulnerable failure points. In order to achieve this goal, the Defense Department established a decentralized standard communication protocol for communication between their computer networks.

A few years later, the National Science Foundation (NSF) wanted to facilitate communication between incompatible network computers at various research institutions across the country. The NSF adopted the Defense Department's protocol for communication, and this combination of research computer networks would eventually evolve into the Internet.

### Internet Protocols

The Defense Department's communication protocol governing data transmission between different networks was called the Internet Protocol (IP) standard. The IP standard has been widely adopted for the transmission of discrete information packets across network boundaries. In fact, the IP standard is the standard protocol governing communications between computers and networks on the Internet.

The IP standard identifies the types of services to be provided to users and specifies the mechanisms needed to support these services. The IP standard also specifies the upper and lower system interfaces, defines the services to be provided on these interfaces, and outlines the execution environment for services needed in the system.

A transmission protocol, called the Transmission Control Protocol (TCP), was developed to provide connection-oriented, end-to-end data transmission between packet-switched computer networks. The combination of TCP with IP (TCP/IP) forms a suite of protocols for information packet transmissions between computers on the Internet. The TCP/IP standard has also become a standard protocol for use in all packet switching networks that provide connectivity across network boundaries.

In a typical Internet-based communication scenario, data is transmitted from an originating communication device on a first network across a transmission medium to a destination communication device on a second network. After receipt at the second network, the packet is routed through the network to a destination communication device, and the TCP/IP protocol determines this routing. Because of the standard protocols in Internet communications, the IP protocol on the destination communication device decodes the transmitted information into the original information transmitted by the originating device.

### TCP/IP Addressing and Routing

Under the TCP/IP protocols, a computer operating on an IP-based network is assigned a unique physical address called an IP address. The IP address can include: (1) a network ID and number identifying a network, (2) a sub-network ID number identifying a substructure on the network, and (3) a host ID number identifying a particular computer on the sub-network. A header data field in the information packet will include source and destination addresses. The IP addressing scheme imposes a consistent addressing scheme that reflects the internal organization of the network or sub-network.

A router is used to regulate the transmission of information packets into and out of the computer network. Routers interpret the logical address contained in information packet headers and direct the information packets to the intended destination. Information packets addressed between computers on the same network do not pass through a router on the boundary of the network, and as such, these information packets will not clutter the transmission lines outside the network. If data is addressed to a computer outside the network, the router on the network boundary forwards the data onto the greater network.

TCP/IP network protocols define how routers determine the transmission path through a network and across network boundaries. Routing decisions are based upon information in the IP header and corresponding entries in a routing table maintained on the router. A routing table contains the information for a router to determine whether to accept an information packet on behalf of a device or pass the information packet onto another router.

### The IP-Based Mobility System

The Internet protocols were originally developed with an assumption that Internet users would be connected to a single, fixed network. With the advent of cellular wireless communication systems using mobile communication devices, the movement of Internet users within a network and across network boundaries has become common. Because of this highly mobile Internet usage, the implicit design assumption of the Internet protocols (e.g. a fixed user location) is violated by the mobility of the user.

In an IP-based mobile communication system, the mobile communication device (e.g. cellular phone, pager, computer, etc.) can be called a mobile node or mobile station. Typically, a mobile station maintains connectivity to its home network while operating on a visited network. The mobile station will always be associated with its home network for IP addressing purposes and will have information routed to it by routers located on the home and visited networks. The routers can be referred to by a number of names including Home Agent, Home Mobility Manager, Home Location Register, Foreign Agent, Serving Mobility Manager, Visited Location Register, and Visiting Serving Entity.

During the formative years since the Internet was first established, Internet Protocol version 4 (IPv4) was recognized and adopted as the standard version of the Internet Protocol. With the advent of mobile IP and proliferation of computers and computer systems linked to the Internet, various limitations in the IPv4 standard and associated procedures have developed and emerged. In response, new standards are evolving and emerging that offer increasing advantages of speed of data transmission, wireless communication range, and importantly, additional communication services.

The IP-based mobile system includes at least one Mobile Node in a wireless communication system. The term “Mobile Node” includes a mobile communication device (e.g. cellular phone, pager, computer, etc.), and, in addition to the Mobile Node, the communication system has a home network and a foreign network. The Mobile Node may change its point of attachment to a communication system on different networks, but the Mobile Node will always be associated with a single Mobile Node home network for IP addressing purposes.

In many typical systems, the home network has a Home Agent and the foreign network has a Foreign Agent—both of which control the routing of information packets into and out of their network. In the typical mobile IP configuration, the Mobile Node will be coupled by a wireless link (or possibly wired link in some applications) attached to a Foreign Agent correlating with a care-of address used to route information packets to the Mobile Node. The Home Agent will receive and forward information packets addressed to the Mobile Node by appending the care-of address to the information packet, which is routed to the Foreign Agent for final routing to the attached Mobile Node.

The Mobile Node keeps the Home Agent informed of its current location by registering the care-of address with the Home Agent. Essentially, the care-of address represents the current connection on the foreign network at a Foreign Agent where the Mobile Node is located. If the Home Agent receives an information packet addressed to the Mobile Node while the Mobile Node is located on a foreign network, the Home Agent will “tunnel” the information packet to the Mobile Node's current location on the foreign network via the applicable care-of address.

The Foreign Agent participates in informing the Home Agent of the Mobile Node's current care-of address. The Foreign Agent also de-tunnels information packets for the mobile node after the information packets have been forwarded to the Foreign Agent by the Home Agent. Further, the Foreign Agent serves as a default router for out-going information packets generated by the Mobile Node while connected to the foreign network.

Foreign Agents and Home Agents periodically broadcast an agent advertisement to all nodes on the local network associated with that agent. An agent advertisement is a message from the agent on a network that may be issued under the Mobile IP protocol (RFC 2002) or any other type of communications protocol. This advertisement should include information that is required to uniquely identify a mobility agent (e.g. a Home Agent, a Foreign Agent, etc.) to a mobile node. Mobile Nodes examine the agent advertisement and determine whether they are connected to the home network or a foreign network.

If the Mobile Node is located on its home network, no additional actions need to be taken because information packets will be routed to the Mobile Node according to the standard addressing and routing scheme. If the Mobile Node is visiting a foreign network, however, the Mobile Node obtains appropriate information from the agent advertisement, and transmits a registration request message to its Home Agent. The registration request message will include a care-of address for the Mobile Node.

The registered care-of address identifies the foreign network where the Mobile Node is located, and the Home Agent uses this registered care-of address to tunnel information packets to the foreign network for subsequent transfer to the Mobile Node. A registration reply message may be sent to the Mobile Node by the Home Agent to confirm that the registration process has been successfully completed. In newer standards, Foreign Agents have been eliminated by using newer addressing protocols that do not require a Foreign Agent, but a care-of address is always used to for routing communications with Mobile Nodes on a foreign network or sub-network.

A wireless radio transmission station, which can be comprised of several different components collectively called a Base Station, provides the point of attachment connecting a Mobile Node to a communication network. The Base Station will include a radio transceiver, controller, and other associated entities necessary to operate and communication over multiple communication channels using the appropriate communication protocol operative on the system. An important function of the Base Station is translating information packets into the appropriate data format for transmission over the wireless connection or onto the communication network. The Base Station will be coupled to a Gateway and/or Access Router which interfaces with the communication network to provide routing services to information packets transmitted into or out of the communication network.

### Fast Handovers for Mobile IPv6 (FMIPv6)

The most pressing limitation in the IPv4 standard is the restriction on the number of possible IP addresses imposed by the 32-bit address field size. Under the IPv4 protocol, the same IP addresses must be shared, because there is insufficient address availability for the needs of all users. Mobile IPv6 increases the size of the available address space 400% to 128 bits, which vastly increases the number of available addresses. While the 32-bit address field provides 2³² or approximately 4 billion IP address possibilities, a 128-bit field provides 2128 IP address possibilities.

A number of benefits emerge from this vastly larger available address field. First, there is little chance of exhausting the number of IP addresses. Second, a large address field allows aggregation of many network-prefix routers into a single network-prefix router. Finally, the large address pool allows nodes to auto configure using simple mechanisms.

Mobile IPv6 dispenses with Foreign Agents by deriving a care-of address using an auto-configuration protocol such as router advertisements or using a Dynamic Host Configuration Protocol (DHCP) server on the foreign network. MIPv6 also allows for direct-packet routing between Mobile Nodes and Corresponding Nodes located on an IPv6 network. When the Mobile Node moves onto a Foreign Network, it derives a care-of address which it registers with its Home Agent using a binding update message. Route optimization allows the Mobile Node to send a binding update message to a Corresponding Node as well, which caches the care-of address so that it can communicate by sending packets directly to the Mobile Node. Moreover, the Mobile Node can send a binding update to the Home Agent anycast address, and it will only receive one response from one Home Agent even though multiple home agents may reside on the home network.

When moving from one point of attachment to another, a Mobile Node undergoes a hand-off protocol whereby it registers its location on the foreign network or sub-network with the Home Agent on the home network. Hand-off latency occurs during the registration procedure as the Mobile Node and the Home Agent exchange binding update and other control messages to register the Mobile Node. The Mobile Node may also need to update the care-of address with binding updates on a Corresponding Node or previous access router. This latency is proportional to the round-trip time for a binding update message to reach the Home Agent, the Correspondence Node, or the previous access router. Fast Mobile IPv6 (FMIPv6), or anticipated MIPv6, prepares for hand-off in advance of the actual movement. There are two modes of operation for FMIPv6. In the predictive mode, the hand-off registration is initiated before the Mobile Node handover begins. In the reactive mode, the hand-off registration is initiated after the Mobile Node handover begins. This protocol substantially reduces latency, improving reliability of communication and quality of service and reducing data packet loss.

### WiMAX

Worldwide Interoperability for Microwave Access (WiMAX) is another designation for the IEEE 802.16 standard. The WiMAX standard is an emerging packet-based wireless communication standard. WiMAX can operate in the 2 to 16 GHz range. This communication technology can communicate over distances of up to 50 km (31 miles) of linear service area and permits communication not limited to line-of-sight. Shared data rates of up to 70 Mbits/s are possible with WiMAX, which provides enough communication bandwidth to simultaneously support over 1000 homes at the 1 Mbit/s DSL-level connectivity with excess capacity to spare. Currently, practical data rates transmitting speeds appear limited to between 500 kbits/s and 2 Mbits/s.

The WiMAX protocol supports point-to-multipoint broadband wireless access applications with very high bit rates for both the uplink and the downlink. The access and bandwidth allocations on the system can support hundreds of terminals per channel. Services supported include time-division multiplexing (TDM) voice/data and Internet Protocol connections to include Voice over IP (VoIP), PTT (Push to Talk), VT (Video Telephony), etc. Both continuous and bursty data traffic transmissions must be supported to provide these services. The 802.16 medium access control (MAC) protocol also includes privacy sub-layer providing authentication for network access and connections, and it provides key exchange and encryption for securing packet transmissions.

Mobile standards of WiMAX permits mobile Non Line of Sight (NLOS) communication by enhancing Orthogonal Frequency Division Multiple Access (OFDMA). Each WiMAX base station node should enable high-speed Internet wireless connectivity between home and businesses in a radius of up to 50 km/31 miles. The evolving technology and standard will improve NLOS coverage, increase system gain by use of denser sub-channelization, enhance security and NLOS performance by introducing high-performance coding techniques, introduce downlink sub-channelization, improve coverage, eliminate channel bandwidth dependencies on sub-carrier spacing, and use an enhanced algorithm that can tolerate larger delay spread to increase resistance to interference.

New standards and protocols for the WiMAX standard are being developed and implemented. There is no current accepted method for fast hand-off in the WiMAX transmission standard and networks. The invention is a new protocol for implementing fast mobile hand-off for FMIPv6 on the WiMAX communication protocol. As noted above, implementing fast handover on WiMAX would reduce the hand-off latency improving quality of service, reduce loss of data packets, and improve the reliability and efficiency of the system.

### SUMMARY OF THE INVENTION

Four different fast hand-off procedures for performing handover of routing to a new gateway access router includes two predictive protocols and two reactive protocols. The two predictive protocols include 1) Mobile Station (e.g. Mobile Node) initiated fast hand-off and 2) a network initiated fast hand-off procedures. The two reactive protocols include 1) Mobile Station (e.g. Mobile Node) initiated fast hand-off and 2) a network initiated fast hand-off procedures. The four scenarios include a mobile subscriber station initiated predictive hand-off, a network initiated predictive hand-off, a mobile subscriber station initiated reactive hand-off, and a network initiated reactive hand-off.

Internet Protocol control messages for fast hand-off or handover are used on the WiMAX network. The messages integrated with WiMAX include fast binding and fast binding acknowledge messages exchanged between two WiMAX access networks. Other messages used include hand-off initiate, hand-off acknowledge, proxy router advertisement, session information request, and release resources Internet Protocol control messages integrated with WiMAX.

The fast handover protocol includes buffering information packets on the target gateway access router associated with the target base station gaining the mobile subscriber station. A handover initiate message received by the gateway access router initiates buffering of information packets. A fast binding update message transmitted by the mobile subscriber station to the currently coupled gateway access router starts the forwarding of information packets for buffering. Session information messages update the targeted base station and targeted gateway access router with necessary session information to support the communication session. Release resources messages are used to terminate the established communication connection between the serving gateway access router and the serving base station, so that those resources are available for reallocation after the move.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a diagram of a WiMAX communication system that demonstrates operation of the invention;

FIG. 2 is a message flow chart for a Mobile Subscriber Station initiated predictive fast hand-off;

FIG. 3 is a message flow chart for a network initiated predictive fast hand-off;

FIG. 4 is a message flow chart for a Mobile Station initiated reactive fast hand-off; and

FIG. 5 is a message flow chart for a network initiated reactive fast hand-off.

### DETAILED DESCRIPTION OF THE PREFERRED EMBODIMENTS

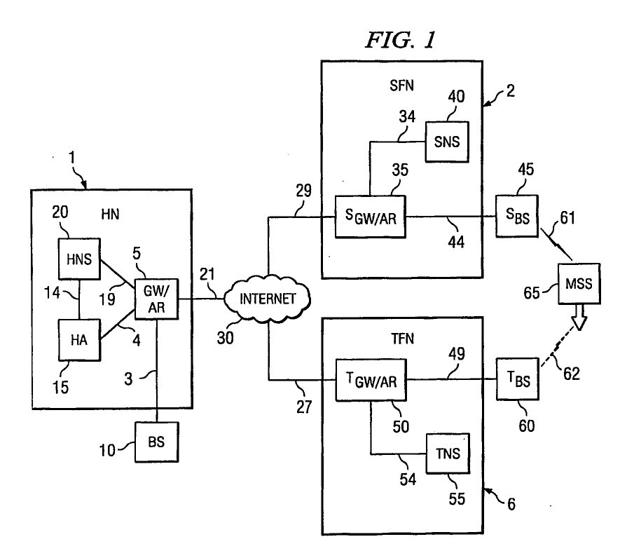

FIG. 1 shows a preferred embodiment of a WiMAX communication system using the invention. FIG. 1 shows a Home Network (HN) 1 connected to the Internet and/or IP based network 30. The Internet and/or IP based network 30 is also connected to a Serving Foreign Network Access Provider (S-NAP) 2 and a Target Network Access Provider (T-NAP) 6. Each of the networks are WiMAX networks and can communicated with each other using the Internet and/or IP based network 30 infrastructure.

The HN 1 includes a Gateway/Access Router (GW/AR) 5 that provides access to the HN 1. The GW/AR 5 is coupled to a Base Station (BS) 10 by communication link 3. The BS 10 includes a the necessary components to establish, maintain, and support wireless communication with mobile devices and includes a controller, transceiver, and associated components for multi-channel packet communication with multiple mobile nodes also referred to as mobile subscriber stations (MSS). The GW/AR 5 is connected to a Home Agent (HA) 15 by communication link 4. The HA 15 is also coupled to a Home Network Server (HNS) 20 by communication link 14, which in turn is connected to the GW/AR 5 by communication link 19. The GW/AR provides access to the Internet and/or IP based network 30 using communication link 21.

The Internet and/or IP based network 30 is coupled to the S-NAP 2 by communication link 29 to the Serving Gateway/Access Router (S-GW/AR) 35, which provides communication access to the S-NAP 2. The S-GW/AR 35 also connects to the Serving Base Station (S-BS) 45 using communication link 44. The S-BS 45 includes the necessary components to establish, maintain, and support wireless communication with multiple mobile devices including the Mobile Subscriber Station (MSS) 65. The MSS 65 communicates with the S-BS 45 over wireless communication link 61. The MSS 65 is associated with the HN 1, and communication arriving on the HN 1 addressed to the MSS 65 is routed to and from the MSS 65 using the HA 15 and GW/AR 5. The S-GW/AR 35 is also connected to a Serving Network Server (SNS) 40 by communication link 34. The MSS 65 is currently coupled to the S-NAP 2 and registered with the HA 15 for this communication connection. Collectively, the S-NAP can also be referred to as an Access Services Network, and the S-GW/AR can be referred to as the Serving ASN GW.

The Internet and/or IP based network 30 is also coupled to the T-NAP 6 by communication link 27 to the Target Gateway/Access Router (T-GW/AR) 50, which provides communication access to the T-NAP 6. The T-GW/AR 50 also connects to the Target Base Station (T-BS) 60 using communication link 49. The T-BS 60 includes the necessary components to establish, maintain, and support wireless communication with multiple mobile devices including the MSS 65. In this embodiment, the MSS 65 is in the process of moving into the geographical area supported by the T-BS 60 and is establishing wireless communication link 62 using a hand-off protocol. The T-GW/AR 50 is also connected to a Target Network Server (TNS) 55 by communication link 54. The MSS 65 is currently coupled to the S-NAP 2 and registered with the HA 15 for this communication connection and must undergo a hand-off to forward packets to the new connection with T-BS 60.

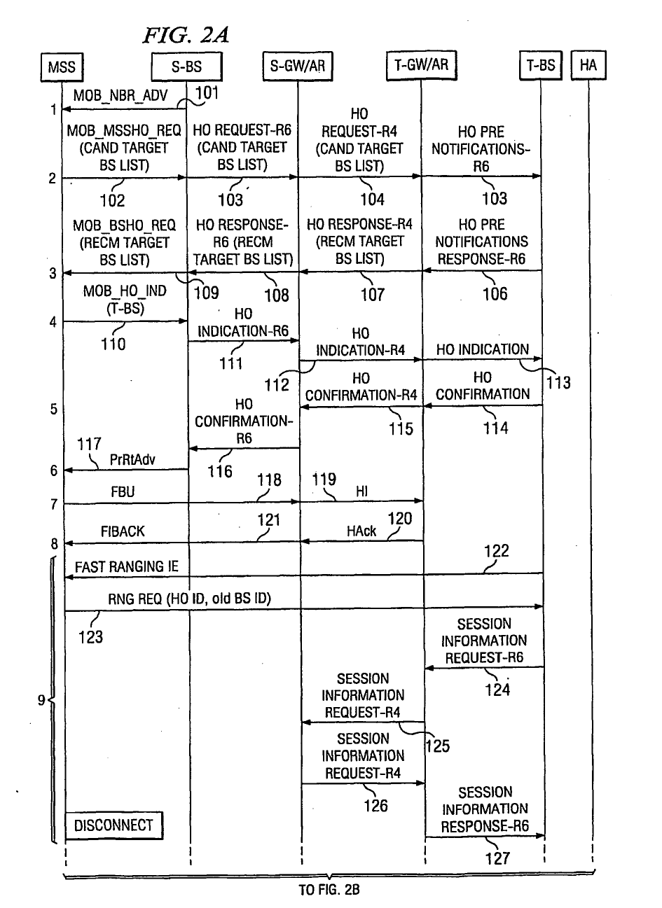

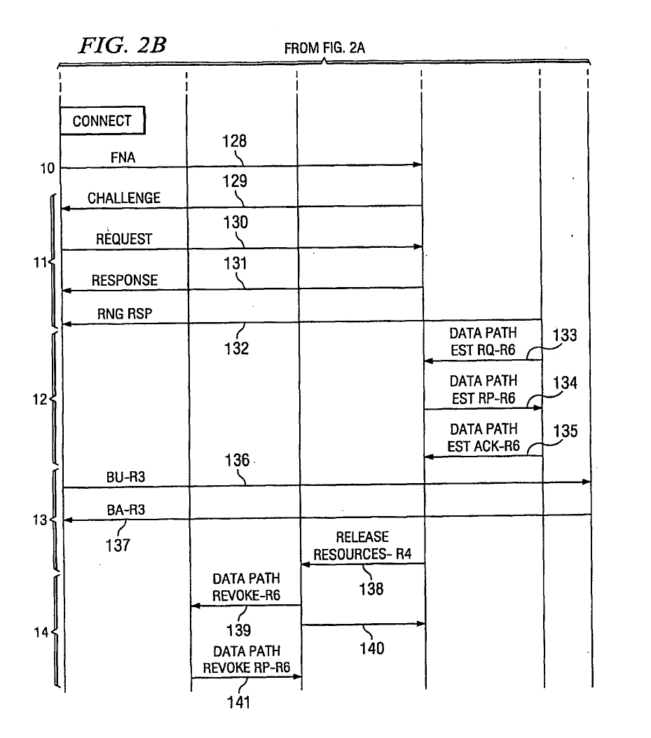

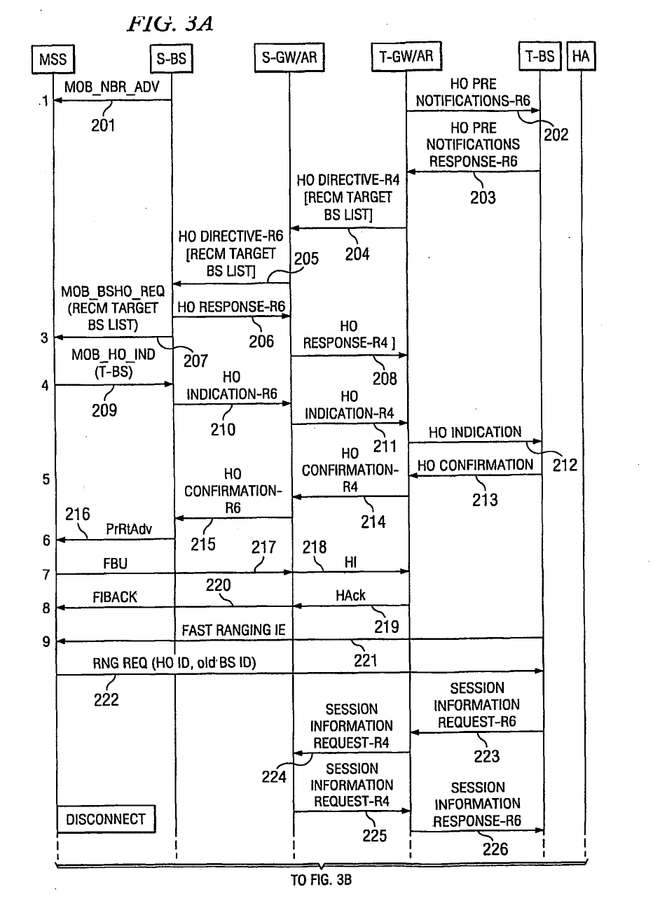

FIG. 2 is a message flow chart for a Mobile Subscriber Station initiated predictive fast hand-off. In normal operation, the MSS should be engaged in periodic scanning of neighboring Base Stations to gather signal quality information, which is forwarded to the S-GW/AR. In step 101, a Mobile Neighbor Advertisement (MOB_NBR_ADV) is received by the MSS from the S-BS. In step 102, the MSS prepares for moving to a new target BS, the T-BS, by transmitting a Mobile MSS Handover Request (MOB_MSSHO_REQ) message to the S-BS to prepare for moving to a new wireless connection, which contains a candidate target list of base stations. In step 103, the S-BS transmits a Handover Request (HO Request) primitives message to the SGW/AR notifying the S-GW/AR to prepare a list of recommended target BSs to transfer to for communication. In step 104, after determining that an inter-ASN handoff is required, the SGW/AR transmits a Handover Request (HO Request) message to the T-GW/AR notifying it for permission to hand-off the MSS. In step 105, the T-GW/AR transmits a Handover Pre-Notification (HO Pre Notification) message to the T-BS to prepare the T-BS to connect with the MSS.

In step 106, the T-BS transmits a Handover Pre Notification Response (HO Pre Notification Response) message to the T-GW/AR indicating it can support communication with the MSS and is prepared to connect with the MSS. In step 107, the T-GW/AR sends a Handover Response (HO Response) message to the S-GW/AR containing a list of recommended BSs for the hand-off. In step 108, the S-GW/AR transmits a Handover Response (HO Response) message to the S-BS that includes the recommended target list of BSs. In step 109, the S-BS transmits the BSs target list to the MSS in a Mobile BS Handover Request (MOB-BSHO_REQ) message.

In step 110, the MSS selects a target BS (T-BS) and initiates the fast hand-off by sending a Mobile Handover Indication (MOB_HO_IND) message to the S-BS. The S-BS sends a Handover Indication (HO Indication) message to the S-GW/AR in step 111 to inform the S-GW/AR of the fast hand-off of the MSS. In step 112, the S-GW/AR transmits a Handover Indication (HO Indication) message to the T-GW/AR informing the T-GW/AR that the MSS will register with the supported T-BS. The T-GW/AR in turn will transmit a Handover Indication (HO Indication) message to the T-BS informing the T-BS or the movement and registration of the MSS in step 113.

In step 114, the T-BS confirms availability for connection to the MSS in a Handover Confirmation (HO Confirmation) message transmitted to the T-GW/AR. The T-GW/AR processes the message and transmits a Handover Confirmation (HO Confirmation) message to the SGW/AR that confirms that the T-BS can support communication with the MSS in step 115. In step 116, the S-GW/AR transmits a Handover Confirmation (HO Confirmation) message to the S-BS to inform the S-BS that the T-BS can connect to the MSS. In step 117, the S-BS transmits a Proxy Router Advertisement (PrRtAdv) message to the MSS with data on the T-BS for coupling to the S-BS.

In step 118, the MSS transmits a Fast Binding Update (FBU) message to the S-GW/AR communicating the changing wireless connection, which the S-GW/AR uses to update a routing table entry for forwarding any information packets routed to S-GW/AR after the wireless connection terminates. The S-GW/AR in turn in step 119 transmits a Handover Initiate (HI) message to the T-GW/AR to initiate the handover of the MSS to the new access router. In step 120, a Handover Acknowledge (HAack) is transmitted from the T-GW/AR to the S-GW/AR confirming receipt of the HI message and hand-off to the T-GW/AR. The S-GW/AR then transmits a FBACK message to the MSS indicating the MSS can connect to the T-BS in step 121. Steps 110 through 121 are executed in parallel, and after step 121 information packets received at the S-GW/AR are forwarded to the T-GW/AR for buffering and delivery after the MSS establishes a connection.

In steps 122 through 127, the MSS starts the network re-entry procedure. In step 122, a Fast Ranging Information Element (Fast Ranging IE) message is transmitted from the T-BS to the MSS to provide initial ranging information to the MSS. The MSS responds with a Ranging Request (RNG_REQ) message containing an identification of the handover (HO ID), an identifier for the S-BS (old BS ID), and its quality of service (QoS) requirements in step 123. In step 124, the T-BS transmits a Session Information Request message to the T-GW/AR requesting the session information for the MSS, and the Session Information Request message is forwarded to the S-GW/AR in step 125. The S-GW/AR responds with session information in a Session Information Response message in step 126 transmitted to the T-GW/AR, which processes the message and transmits a Session Information Response message to the T-BS in step 127. This information is used to set the <source port, source IP address> and <destination port, destination IP address> for the communication session. The Session Information Request/Session Information Response messages can be optional with the required information contained in the MOB_HO_IND message, and can also be used by the T-GW/AR to obtain required information from the S-GW/AR. At this point, the MSS disconnects from the S-BS and connects to the T-BS.

In step 128, the MSS looses its connection to the serving network (S-NAP 2) and gains connection to the target network (T-NAP 6). Information packets addressed to the MSS received after step 121 are buffered on the T-GW. The MSS transmits a Fast Neighbor Advertisement (FNA) message to the T-GW/AR to announce attachment to the T-BS, which triggers the delivery of buffered packets to the MSS. In step 129, a Challenge message is transmitted from the T-GW/AR to the MSS to request authentication and authorization information from the MSS. The MSS responds with a Request message in step 130 requesting secured authorization and authentication data, which it processes to generate a correct data response in a Response message transmitted to the T-GW/AR in Step 131. In step 132, the T-BS generates a response to the RNG_REQ of step 123 to transmit QoS information to the MSS in a Range Response (RNG_RSP) message and includes information for compensating for frequency, time, and transmit power for the ranging.

In step 133-135, the T-BS establishes a connection with the T-GW/AR for the communication session. In step 133, the T-BS transmits a Data Path Establishment Request (Data Path Est RQ) message to the T-GW/AR. The T-GW/AR responds with a Data Path Establishment Reply (Data Path Est RP) message in step 134, and the T-BS acknowledges the message and established data path between the T-BS and the T-GW/AR with a Data Path Establish Aclcnowledge (Data Path Est Ack) message in step 135. The steps 129-135 can occur in parallel.

In step 136, the Home Agent (HA) is updated with the new location of the MSS using a Binding Update message transmitted from the MSS, and the HA responds in step 137 with a Binding Acknowledge (BA) message confirming the update of the location of the MSS on the HA routing tables. From this point on, all packets received on the home network addressed to the MSS are forwarded to the T-GW/AR for routing to the MSS. In step 138, the T-GW/AR starts releasing the communication resources to the S-BS by transmitting a Release Resources message to the S-GW/AR, which in response transmits a Data Path Revoke message to the S-BS in step 139, terminating the connection to the S-BS for the MSS. In step 140, a Release Resources Acknowledge (Release Resources Aclc) message is sent to the S-GW/AR from the TGW/AR to acknowledge receipt of the Release Resources message. In step 141, a Data Path Revoke Reply (Data Path Revoke RP) message to confirm receipt of the Data Path Revoke message and release of resources.

In this embodiment, the integration of the PrRtAdv, FBU, HI, HAck, FBACK, Session Information Request, Session Information Response, FNA and Release Resources messages between the MSS, the S-BS, the T-BS, the S-GW/AR, and the T-GW/AR are unique and not found in the prior art. The addition of these messages allows the WiMAX protocol to perform predictive Fast Handover with the MSS initiating the hand-off.

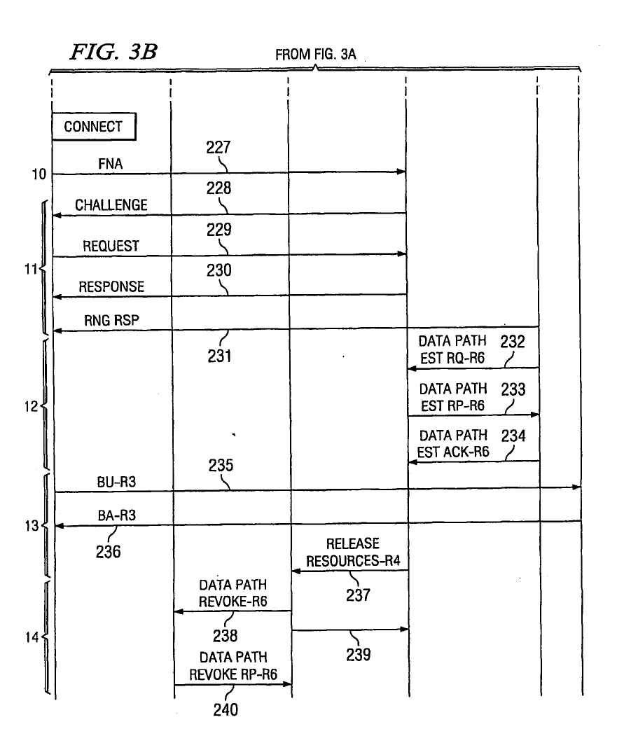

FIG. 3 is a message flow chart for a network initiated predictive fast hand-off. In normal operation, the MSS should be engaged in periodic scanning of neighboring Base Stations to gather signal quality information, which is forwarded to the S-GW/AR. In step 201, a Mobile Neighbor Advertisement (MOB_NBR_ADV) is received by the MSS from the S-BS. In step 202, the T-GW/AR transmits a Handover Pre-Notification (HO Pre Notification) message to the T-BS to prepare the T-BS to connect with the MSS.

In step 203, the T-BS transmits a Handover Pre Notification Response (HO Pre Notification Response) message to the T-GW/AR indicating it can support communication with the MSS and is prepared to connect with the MSS. In step 204, the T-GW/AR transmits a Handover Directive (HO Directive) message to the S-GW/AR containing a list of recommended Base Stations for connecting the MSS. In step 205, the S-GW/AR transmits a Handover Directive (HO Directive) message to the S-BS with the list of recommended Base Stations, and the S-BS transmits a Handover Response (HO Response) message to the S-GW/AR confirming receipt in step 206. The S-GW/AR also transmits the list to the MSS in a Mobile Base Station Handover Request (MOB_BSHO_REQ) to the MSS in step 207. In step 208, the S-GW/AR transmits a HO Response message to the T-GW/AR.

In step 209, the MSS selects a target BS (T-BS) and initiates the fast hand-off by sending a Mobile Handover Indication (MOB_HO_IND) message to the S-BS. The S-BS sends a Handover Indication (HO Indication) message to the S-GW/AR in step 210 to inform the S-GW/AR of the fast hand-off of the MSS. In step 211, the S-GW/AR transmits a Handover Indication (HO Indication) message to the T-GW/AR informing the T-GW/AR that the MSS will register with the supported T-BS. The T-GW/AR in turn will transmit a Handover Indication (HO Indication) message to the T-BS informing the T-BS or the movement and registration of the MSS in step 212.

In step 213, the T-BS confirms availability for connection to the MSS in a Handover Confirmation (HO Confirmation) message transmitted to the T-GW/AR. The T-GW/AR processes the message and transmits a Handover Confirmation (HO Confirmation) message to the SGW/AR that confirms that the T-BS can support communication with the MSS in step 214. In step 215, the S-GW/AR transmits a Handover Confirmation (HO Confirmation) message to the S-BS to inform the S-BS that the T-BS can connect to the MSS. In step 216, the S-BS transmits a Proxy Router Advertisement (PrRtAdv) message to the MSS with data on the T-BS for coupling to the S-BS.

In step 217, the MSS transmits a Fast Binding Update (FBU) message to the S-GW/AR communicating the changing wireless connection, which the S-GW/AR uses to update a routing table entry for forwarding any information packets routed to S-GW/AR after the wireless connection terminates. The S-GW/AR in turn in step 218 transmits a Handover Initiate (HI) message to the T-GW/AR to initiate the handover of the MSS to the new access router. In step 219, a Handover Acknowledge (HAck) is transmitted from the T-GW/AR to the S-GW/AR confirming receipt of the HI message and hand-off to the T-GW/AR. The S-GW/AR then transmits a FBACK message to the MSS indicating the MSS can connect to the T-BS in step 220. Steps 209 through 220 are executed in parallel, and after step 220 information packets received at the S-GW/AR are forwarded to the T-GW/AR for buffering and delivery after the MSS establishes a connection.

In steps 221 through 226, the MSS starts the network re-entry procedure. In step 221, a Fast Ranging Information Element (Fast Ranging IE) message is transmitted from the T-BS to the MSS to provide initial ranging information to the MSS. The MSS responds with a Ranging Request (RNG_REQ) message containing an identification of the handover (HO ID), an identifier for the S-BS (old BS ID), and its quality of service (QoS) requirements in step 222. In step 223, the T-BS transmits a Session Information Request message to the T-GW/AR requesting the session information for the MSS, and the Session Information Request message is forwarded to the S-GW/AR in step 224. The S-GW/AR responds with session information in a Session Information Response message in step 225 transmitted to the T-GW/AR, which processes the message and transmits a Session Information Response message to the T-BS in step 226. This information is used to set the <source port, source IP address> and <destination port, destination IP address> for the communication session. The Session Information Request/Session Information Response messages can be optional with the required information contained in the MOB_HO_IND message, and can also be used by the T-GWIAR to obtain required information from the S-GW/AR. At this point, the MSS disconnects from the S-BS and connects to the T-BS.

In step 227, the MSS looses its connection to the serving network (S-NAP 2) and gains connection to the target network (T-NAP 6). Information packets addressed to the MSS received after step 220 are buffered on the T-GW. The MSS transmits a Fast Neighbor Advertisement (FNA) message to the T-GW/AR to announce attachment to the T-BS, which triggers the delivery of buffered packets to the MSS. In step 228, a Challenge message is transmitted from the T-GW/AR to the MSS to request authentication and authorization information from the MSS. The MSS responds with a Request message in step 229 requesting secured authorization and authentication data, which it processes to generate a correct data response in a Response message transmitted to the T-GW/AR in step 230. In step 231, the T-BS generates a response to the RNG_REQ of step 222 to transmit QoS information to the MSS in a Range Response (RNG_RSP) message and includes information for compensating for frequency, time, and transmit power for the ranging.

In step 232-234, the T-BS establishes a connection with the T-GW/AR for the communication session. In step 232, the T-BS transmits a Data Path Establishment Request (Data Path Est RQ) message to the T-GW/AR. The T-GW/AR responds with a Data Path Establishment Reply (Data Path Est RP) message in step 233, and the T-BS acknowledges the message and established data path between the T-BS and the T-GW/AR with a Data Path Establish Aclcnowledge (Data Path Est Ack) message in step 234. The steps 228-234 can occur in parallel.

In step 235, the Home Agent (HA) is updated with the new location of the MSS using a Binding Update message transmitted from the MSS, and the HA responds in step 236 with a Binding Acknowledge (BA) message confirming the update of the location of the MSS on the HA routing tables. From this point on, all packets received on the home network addressed to the MSS are forwarded to the T-GW/AR for routing to the MSS. In step 237, the T-GW/AR starts releasing the communication resources to the S-BS by transmitting a Release Resources message to the S-GW/AR, which in response transmits a Data Path Revoke message to the S-BS in step 238, terminating the connection to the S-BS for the MSS. In step 239, a Release Resources Acknowledge (Release Resources Ack) message is sent to the S-GW/AR from the TGW/AR to acknowledge receipt of the Release Resources message. In step 240, a Data Path Revoke Reply (Data Path Revoke RP) message to confirm receipt of the Data Path Revoke message and release of resources.

In this embodiment, the integration of the HO Directive, HO Response, PrRtAdv, FBU, HI, HAck, FBACK, Session Information Request, Session Information Response, FNA and Release Resources messages between the MSS, the S-BS, T-BS, the S-GW/AR and the T-GW/AR are unique and not found in the prior art. The addition of these messages allows the WiMAX protocol to perform predictive Fast Handover with the Network initiating the hand-off.

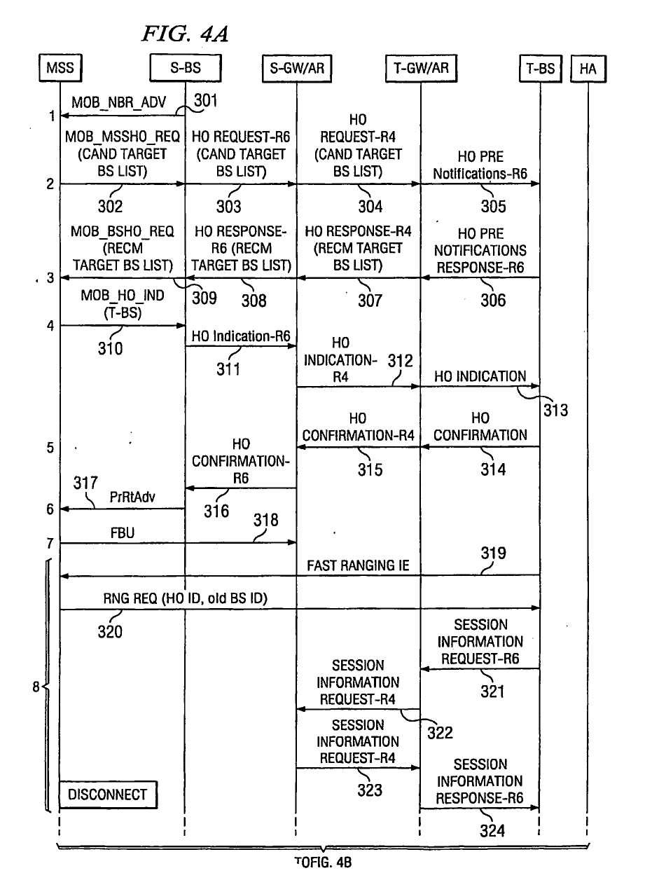

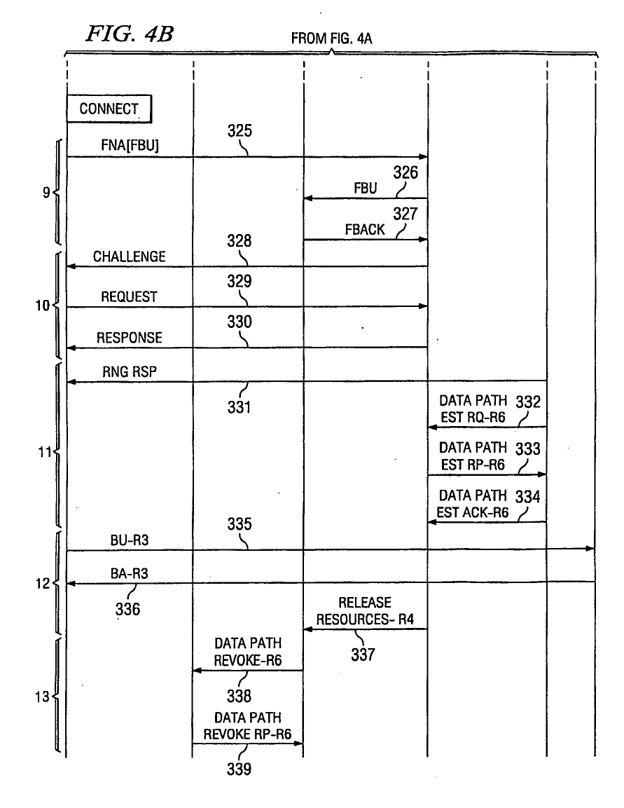

FIG. 4 is a message flow chart for a Mobile Subscriber Station initiated reactive fast hand-off. In normal operation, the MSS should be engaged in periodic scanning of neighboring Base Stations to gather signal quality information, which is forwarded to the S-GW/AR. In step 301, a Mobile Neighbor Advertisement (MOB_NBR_ADV) is received by the MSS from the S-BS. In step 302, the MSS prepares for moving to a new target BS, the T-BS, by transmitting a Mobile MSS Handover Request (MOB_MSSHO_REQ) message to the S-BS to prepare for moving to a new wireless connection, which contains a candidate target list of base stations. In step 303, the S-BS transmits a Handover Request (HO Request) primitives message to the SGW/AR notifying the S-GW/AR to prepare a list of recommended target BSs to transfer to for communication. In step 304, after determining that an inter-ASN handoff is required, the SGW/AR transmits a Handover Request (HO Request) to the T-GW/AR notifying it for permission to hand-off the MSS. In step 305, the T-GW/AR transmits a Handover Pre-Notification (HO Pre Notification) message to the T-BS to prepare the T-BS to connect with the MSS.

In step 306, the T-BS transmits a Handover Pre Notification Response (HO Pre Notification Response) message to the T-GW/AR indicating it can support communication with the MSS and is prepared to connect with the MSS. In step 307, the T-GW/AR sends a Handover Response (HO Response) message to the S-GW/AR containing a list of recommended BSs for the hand-off. In step 308, the S-GW/AR transmits a Handover Response (HO Response) message to the S-BS that includes the recommended target list of BSs. In step 309, the S-BS transmits the BSs target list to the MSS in a Mobile BS Handover Request (MOB-BSHO_REQ) message.

In step 310, the MSS selects a target BS (T-BS) and initiates the fast hand-off by sending a Mobile Handover Indication (MOB_HO_IND) message to the S-BS. The S-BS sends a Handover Indication (HO Indication) message to the S-GW/AR in step 311 to inform the S-GW/AR of the fast hand-off of the MSS. In step 312, the S-GW/AR transmits a Handover Indication (HO Indication) message to the T-GW/AR informing the T-GW/AR that the MSS will register with the supported T-BS. The T-GW/AR in turn will transmit a Handover Indication (HO Indication) message to the T-BS informing the T-BS of the movement and registration of the MSS in step 313.

In step 314, the T-BS confirms availability for connection to the MSS in a Handover Confirmation (HO Confirmation) message transmitted to the T-GW/AR. The T-GW/AR processes the message and transmits a Handover Confirmation (HO Confirmation) message to the SGW/AR that confirms that the T-BS can support communication with the MSS in step 315. In step 316, the S-GW/AR transmits a Handover Confirmation (HO Confirmation) message to the S-BS to inform the S-BS that the T-BS can connect to the MSS. In step 317, the S-BS transmits a Proxy Router Advertisement (PrRtAdv) message to the MSS with data on the T-BS for coupling to the S-BS. In step 318, the MSS transmits a Fast Binding Update (FBU) message to the S-GW/AR communicating the changing wireless connection, which the S-GW/AR uses to update a routing table entry for forwarding any information packets routed to S-GW/AR after the wireless connection terminates. Steps 310 through 319 are executed in parallel, and after step 318 information packets received at the S-GW/AR are forwarded to the T-GW/AR for buffering and delivery after the MSS establishes a connection.

In steps 319 through 324, the MSS starts the network re-entry procedure. In step 319, a Fast Ranging Information Element (Fast Ranging IE) message is transmitted from the T-BS to the MSS to provide initial ranging information to the MSS. The MSS responds with a Ranging Request (RNG_REQ) message containing an identification of the handover (HO ID), an identifier for the S-BS (old BS ID), and its quality of service (QoS) requirements in step 320. In step 321, the T-BS transmits a Session Information Request message to the T-GW/AR requesting the session information for the MSS, and the Session Information Request message is forwarded to the S-GW/AR in step 322. The S-GW/AR responds with session information in a Session Information Response message in step 323 transmitted to the T-GW/AR, which processes the message and transmits a Session Information Response message to the T-BS in step 324. This information is used to set the <source port, source IP address> and destination port, destination IP address> for the communication session. The Session Information Request/Session Information Response messages can be optional with the required information contained in the MOB_HO IND message, and can also be used by the T-GW/AR to obtain required information from the S-GW/AR. At this point, the MSS disconnects from the S-BS and connects to the T-BS.

In step 325, the MSS looses its connection to the serving network (S-NAP 2) and gains connection to the target network (T-NAP 6). The MSS detects linkup with the T-BS. Information packets addressed to the MSS received after step 318 have been buffered on the T-GW. The MSS transmits a Fast Neighbor Advertisement (FNA) message encapsulating a Fast Binding Update (FBU) message to the T-GW/AR to announce attachment to the T-BS and update the binding address, which triggers the delivery of buffered packets to the MSS. In step 326, the TGW/AR transmits a FBU message to the S-GW/AR, which updates the routing table to route any additionally received information packets to the new address corresponding to the connection to the T-GW/AR In step 327, the T-GW/AR acknowledges the connection with a Fast Binding Acknowledge (FBack) message sent to the T-GW/AR.

In step 328, a Challenge message is transmitted from the T-GW/AR to the MSS to request authentication and authorization information from the MSS. The MSS responds with a Request message in step 329 requesting secured authorization and authentication data, which it processes to generate a correct data response in a Response message transmitted to the TGW/AR in Step 330. In step 331, the T-BS generates a response to the RNG_REQ of step 319 to transmit QoS information to the MSS in a Range Response (RNG_RSP) message and includes information for compensating for frequency, time, and transmit power for the ranging.

In steps 332-334, the T-BS establishes a connection with the T-GW/AR for the communication session. In step 332, the T-BS transmits a Data Path Establishment Request (Data Path Est RQ) message to the T-GW/AR. The T-GW/AR responds with a Data Path Establishment Reply (Data Path Est RP) message in step 333, and the T-BS acknowledges the message and established data path between the T-BS and the T-GW/AR with a Data Path Establish Acknowledge (Data Path Est Ack) message in step 334. The steps 328-334 can occur in parallel.

In step 335, the Home Agent (HA) is updated with the new location of the MSS using a Binding Update message transmitted from the MSS, and the HA responds in step 336 with a Binding Acknowledge (BA) message confirming the update of the location of the MSS on the HA routing tables. From this point on, all packets received on the home network addressed to the MSS are forwarded to the T-GW/AR for routing to the MSS. In step 337, the T-GW/AR starts releasing the communication resources to the S-BS by transmitting a Release Resources message to the S-GW/AR, which in response transmits a Data Path Revoke message to the S-BS in step 338, terminating the connection to the S-BS for the MSS. In step 339, a Data Path Revoke Reply (Data Path Revoke RP) message to confirm receipt of the Data Path Revoke message and release of resources.

In this embodiment, the integration of the PrRtAdv, Session Information Request, Session Information Response, FBU, FNA encapsulating a FBU, FBACK, and Release Resources messages between the MSS, the S-BS, the T-BS, the S-GW/AR and the T-GW/AR are unique and not found in the prior art. The addition of these messages allows the WiMAX protocol to perform reactive Fast Handover with the MSS initiating the hand-off.

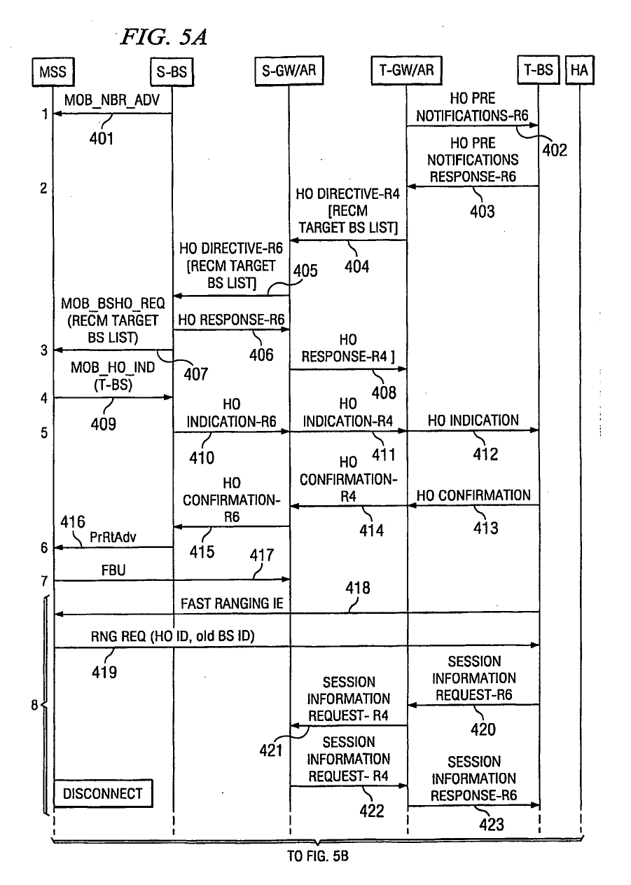

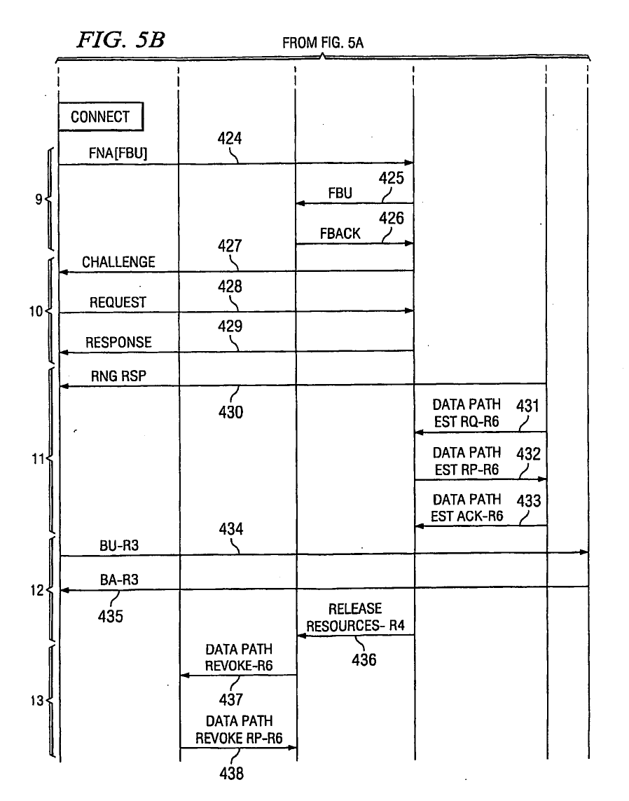

FIG. 5 is a message flow chart for a network initiated reactive fast hand-off. In normal operation, the MSS should be engaged in periodic scanning of neighboring Base Stations to gather signal quality information, which is forwarded to the S-GW/AR. In step 401, a Mobile Neighbor Advertisement (MOB_NBR_ADV) is received by the MSS from the S-BS. In step 402, the T-GW/AR transmits a Handover Pre-Notification (HO Pre Notification) message to the T-BS to prepare the T-BS to connect with the MSS.

In step 403, the T-BS transmits a Handover Pre Notification Response (HO Pre Notification Response) message to the T-GW/AR indicating it can support communication with the MSS and is prepared to connect with the MSS. In step 404, the T-GW/AR transmits a Handover Directive (HO Directive) message to the S-GW/AR containing a list of recommended Base Stations for connecting the MSS. In step 405, the S-GW/AR transmits a Handover Directive (HO Directive) message to the S-BS with the list of recommended Base Stations, and the S-BS transmits a Handover Response (HO Response) message to the S-GW/AR confirming receipt in step 406. The S-GW/AR also transmits the list to the MSS in a Mobile Base Station Handover Request (MOB_BSHO_REQ) to the MSS in step 407. In step 408, the S-GW/AR transmits a HO Response message to the T-GW/AR.

In step 409, the MSS selects a target BS (T-BS) and initiates the fast hand-off by sending a Mobile Handover Indication (MOB_HO_IND) message to the S-BS. The S-BS sends a Handover Indication (HO Indication) message to the S-GW/AR in step 410 to inform the S-GW/AR of the fast hand-off of the MSS. In step 411, the S-GW/AR transmits a Handover Indication (HO Indication) message to the T-GW/AR informing the T-GW/AR that the MSS will register with the supported T-BS. The T-GW/AR in turn will transmit a Handdver Indication (HO Indication) message to the T-BS informing the T-BS or the movement and registration of the MSS in step 412.

In step 413, the T-BS confirms availability for connection to the MSS in a Handover Confirmation (HO Confirmation) message transmitted to the T-GW/AR. The T-GW/AR processes the message and transmits a Handover Confirmation (HO Confirnation) message to the SGW/AR that confirms that the T-BS can support communication with the MSS in step 214. In step 415, the S-GW/AR transmits a Handover Confirmation (HO Confirmation) message to the S-BS to inform the S-BS that the T-BS can connect to the MSS. In step 416, the S-BS transmits a Proxy Router Advertisement (PrRtAdv) message to the MSS with data on the T-BS for coupling to the S-BS.

In step 417, the MSS transmits a Fast Binding Update (FBU) message to the S-GW/AR communicating the changing wireless connection, which the S-GW/AR uses to update a routing table entry for forwarding any information packets routed to S-GW/AR after the wireless connection terminates. Steps 409 through 419 are executed in parallel, and after step 417 information packets received at the S-GW/AR are forwarded to the T-GW/AR for buffering and delivery after the MSS establishes a connection.

In steps 418 through 423, the MSS starts the network re-entry procedure. In step 418, a Fast Ranging Information Element (Fast Ranging IE) message is transmitted from the T-BS to the MSS to provide initial ranging information to the MSS. The MSS responds with a Ranging Request (RNG_REQ) message containing an identification of the handover (HO ID), an identifier for the S-BS (old BS ID), and its quality of service (QoS) requirements in step 419. In step 420, the T-BS transmits a Session Information Request message to the T-GW/AR requesting the session information for the MSS, and the Session Information Request message is forwarded to the S-GW/AR in step 421. The S-GW/AR responds with session information in a Session Information Response message in step 422 transmitted to the T-GW/AR, which processes the message and transmits a Session Information Response message to the T-BS in step 423. This information is used to set the <source port, source IP address> and <destination port, destination IP address> for the communication session. The Session Information Request/Session Information Response messages can be optional with the required information contained in the MOB_HO_IND message, and can also be used by the T-GW/AR to obtain required information from the S-GW/AR. At this point, the MSS disconnects from the S-BS and connects to the T-BS.

In step 424, the MSS looses its connection to the serving network (S-NAP 2) and gains connection to the target network (T-NAP 6). Information packets addressed to the MSS received after step 417 have been buffered on the T-GW. The MSS transmits a Fast Neighbor Advertisement (FNA) message encapsulating a Fast Binding Update (FBU) message to the TGW/AR to announce attachment to the T-BS and update the binding address, which triggers the delivery of buffered packets to the MSS. In step 425, the T-GW/AR transmits a FBU message to the S-GW/AR, which updates the routing table to route any additionally received information packets to the new address corresponding to the connection to the T-GW/AR In step 426, the T-GW/AR acknowledges the connection with a Fast Binding Acknowledge (FBACK) message sent to the T-GW/AR.

In step 427, a Challenge message is transmitted from the T-GW/AR to the MSS to request authentication and authorization information from the MSS. The MSS responds with a Request message in step 428 requesting secured authorization and authentication data, which it processes to generate a correct data response in a Response message transmitted to the TGW/AR in Step 429. In step 430, the T-BS generates a response to the RNG_REQ of step 419 to transmit QoS information to the MSS in a Range Response (RNG_RSP) message and includes information for compensating for frequency, time, and transmit power for the ranging.

In steps 431-433, the T-BS establishes a connection with the T-GW/AR for the communication session. In step 431, the T-BS transmits a Data Path Establishment Request (Data Path Est RQ) message to the T-GW/AR. The T-GW/AR responds with a Data Path Establishment Reply (Data Path Est RP) message in step 432, and the T-BS acknowledges the message and established data path between the T-BS and the T-GW/AR with a Data Path Establish Aclknowledge (Data Path Est Ack) message in step 433. The steps 424-433 can occur in parallel.

In step 434, the Home Agent (HA) is updated with the new location of the MSS using a Binding Update message transmitted from the MSS, and the HA responds in step 435 with a Binding Acknowledge (BA) message confirming the update of the location of the MSS on the HA routing tables. From this point on, all packets received on the home network addressed to the MSS are forwarded to the T-GW/AR for routing to the MSS. In step 436, the T-GW/AR starts releasing the communication resources to the S-BS by transmitting a Release Resources message to the S-GW/AR, which in response transmits a Data Path Revoke message to the S-BS in step 437, terminating the connection to the S-BS for the MSS. In step 438, a Data Path Revoke Reply (Data Path Revoke RP) message to confun receipt of the Data Path Revoke message and release of resources.

In this embodiment, the integration of the HO Directive, HO Response, PrRtAdv, FBU, FNA encapsulating an FBU, FBACK, Session Information Request, Session Information Response and Release Resources messages between the MSS, the S-BS, the T-BS, the S-GW/AR and the T-GW/AR are unique and not found in the prior art. The addition of these messages allows the WiMAX protocol to perform reactive with the Network initiating the hand-off.

While the invention has been particularly shown and described with respect to preferred embodiments, it will be readily understood that minor changes in the details of the invention may be made without departing from the spirit of the invention.

Having described the invention, we claim:

1. A first Microwave Access network, comprising:
a gateway access router coupled to a base station transceiver supporting microwave frequency communication in a communication coverage area, said first Microwave Access network operating a fast handover protocol on a mobile Internet Protocol communication standard for supporting movement of a mobile subscriber station coupled to the base station transceiver;
a network server coupled to said gateway access router;
said mobile subscriber station associated with a home network, said home network updated with the location of the mobile subscriber station using a binding update message transmitted from the mobile subscriber station; and
said fast hand-off protocol using Internet Protocol control messages integrated with Microwave Access control messages to perform the fast handover, including a fast binding update message received by the gateway access router and a fast binding acknowledge message transmitted by the gateway access router.

2. The first Microwave Access network of claim 1, further comprising:
the mobile subscriber station predictively initiating fast handover;
a fast binding update message received from the mobile subscriber station at the gateway access router on the first Microwave Access network, said fast binding update message initiating transmission of a hand-off initiate message.

3. The first Microwave Access network of claim 2, further comprising:
a hand-off acknowledge message received at the gateway access router on the first Microwave Access network initiating transmission of a fast binding acknowledge message to the mobile subscriber station; and

4. The first Microwave Access network of claim 2, further comprising:
a fast neighbor advertisement message received from the mobile subscriber station that initiates transmitting buffered packets addressed to the mobile subscriber station.

5. The first Microwave Access network of claim 1, further comprising:
the first Microwave Access network predictively initiating fast handover;
a handover directive message received at the gateway access router of the first Microwave Access network containing a list of recommended base stations associated with a second Microwave Access network for connecting to the mobile subscriber station.

6. The first Microwave Access network of claim 5, further comprising:
a fast binding update message received from the mobile subscriber station at the gateway access router of the first Microwave Access network, said fast binding update message initiating transmission of a hand-off initiate message.

7. The first Microwave Access network of claim 5, further comprising:
a hand-off acknowledge message received at the gateway access router of the first Microwave Access network initiating transmission of a fast binding acknowledge message to the mobile subscriber station.

8. The first Microwave Access network of claim 5, further comprising:
a fast neighbor advertisement message received from the mobile subscriber station that initiates transmitting buffered packets addressed to the mobile subscriber station.

9. The first Microwave Access network of claim 1, further comprising:
the mobile subscriber station reactively initiating fast handover;
a first fast binding update message received from the mobile sub-scriber station at the gateway access router of the first Microwave Access network that initiates transmitting information packets addressed to the mobile subscriber station to a second Microwave Access network for buffering; and
a second fast binding update message received from the second Microwave Access network at the gateway access router of the first Microwave Access network that updates routing tables to route any additional received information addressed to the mobile subscriber station to the new location.

10. The first Microwave Access network of claim 9, further comprising:
a fast neighbor advertisement message encapsulating a fast binding update message transmitted from the mobile subscriber station, said fast neighbor advertisement message initiates transmitting buffered packets addressed to the mobile subscriber station.

11. The first Microwave Access network of claim 1, further comprising:
the first Microwave Access network reactively initiating fast handover;
a first fast binding update message received from the mobile sub-scriber station at the gateway access router of the first Microwave Access network that initiates transmitting information packets addressed to the mobile subscriber station to the second Microwave Access network for buffering; and
a second fast binding update message received from the second Microwave Access network at the gateway access router of the first Microwave Access network that updates routing tables to route any additional received information addressed to the mobile subscriber station to the new location.

12. The first Microwave Access network of claim 11, further comprising:
a fast neighbor advertisement message encapsulating a fast binding update message transmitted from the mobile subscriber, said fast neighbor advertisement message initiates transmitting buffered information packets addressed to the mobile subscriber station.

13. A method for performing a fast hand-off of a mobile subscriber station coupling to a Microwave Access, comprising the steps of:
preparing a gateway access router to assist with fast hand-off, said gateway access router coupled to a base station transceiver establishing communication with the mobile subscriber station and operating a mobile communication protocol,
operating a mobile Internet Protocol communication standard on the first Microwave Access network to communicate with a linked mobile subscriber station;
initiating a fast handover protocol for supporting movement of the mobile subscriber station from the first Microwave Access network, said fast handover protocol using Internet Protocol control messages integrated with Microwave Access control messages to perform the fast handover, including a fast binding update message received by the gateway access router on the first Microwave Access network and a fast binding acknowledge message transmitted by the gateway access router on the first Microwave Access network; and
maintaining mobile subscriber station association with a home network by updating the location of the mobile subscriber station using a binding update message transmitted from the mobile subscriber station.

14. The method for performing a fast hand-off from a Microwave Access networks having a gateway access router coupled to a base station transceiver and operating a mobile communication protocol of claim 13, further comprising the steps of:
initiating the fast handover predictively using the mobile sub-scriber station;
receiving a fast binding update message at the gateway access router on the first Microwave Access network from the mobile subscriber station, said fast binding update message initiating transmission of a hand-off initiate message;
receiving a hand-off acknowledge message at the gateway access router on the first Microwave Access network initiating transmission of a fast binding acknowledge message to the mobile subscriber station; and
transmitting a fast neighbor advertisement message from the mobile subscriber station that initiates transmitting buffered information packets addressed to the mobile subscriber station.

15. The method for performing a fast hand-off from a Microwave Access networks having a gateway access router coupled to a base station transceiver and operating a mobile communication protocol of claim 13, further comprising the steps of:
initiating fast handover predictively using the first Microwave Access network;
receiving a handover directive message at the gateway access router on the first Microwave Access network containing a list of recommended base stations associated with a second Microwave Access network for connecting to the mobile subscriber station;
receiving a fast binding update message at the gateway access router on the first Microwave Access network from the mobile subscriber station, said fast binding update message initiating transmission of a hand-off initiate message;
receiving a hand-off acknowledge message at the gateway access router on the first Microwave Access network initiating transmission of a fast binding acknowledge message to the mobile subscriber station; and
transmitting a fast neighbor advertisement message from the mobile subscriber station that initiates transmitting buffered packets addressed to the mobile subscriber station.

16. The method for performing a fast hand-off from a Microwave Access networks having a gateway access router coupled to a base station trans-ceiver and operating a mobile communication protocol of claim 13, further comprising the steps of:
initiating fast handover reactively using the mobile subscriber station;
receiving a first fast binding update message at the gateway access router on the first Microwave Access network from the mobile subscriber station that initiates transmitting information packets addressed to the mobile subscriber station to a second Microwave Access network for buffering; and
receiving a second fast binding update message at the gateway access router on the first Microwave Access network from the second Microwave Access network that updates routing tables to route any additional received information packets addressed to the mobile subscriber station to the new location.

17. The method for performing a fast hand-off from a Microwave Access networks having a gateway access router coupled to a base station trans-ceiver and operating a mobile communication protocol of claim 16, further comprising the step of:
transmitting a fast neighbor advertisement message encapsulating a fast binding update message from the mobile subscriber station, said fast neighbor advertisement message initiates transmitting buffered packets addressed to the mobile subscriber station.

18. The method for performing a fast hand-off from a Microwave Access networks having a gateway access router coupled to a base station trans-ceiver and operating a mobile communication protocol of claim 13, further comprising the steps of:
initiating fast handover reactively using the first Microwave Access network;
receiving a first fast binding update message at the gateway access router on the gateway access router on the first Microwave Access network received from the mobile subscriber station that initiates transmitting information packets addressed to the mobile subscriber station to a second Microwave Access network for buffering; and
receiving a second fast binding update message at the gateway access router on the first Microwave Access network from the second Microwave Access network that updates routing tables to route any additional received information addressed to the mobile subscriber station to the new location.

19. The method for performing a fast hand-off from a Microwave Access networks having a gateway access router coupled to a base station trans-ceiver and operating a mobile communication protocol of claim 18, further comprising the step of:
transmitting a fast neighbor advertisement message encapsulating a fast binding update message from the mobile subscriber station, said fast neighbor advertisement message initiates transmitting buffered information packets addressed to the mobile subscriber station.

20. A method for performing a fast hand-off protocol from a Microwave Access network, comprising the steps of:
providing a first Microwave Access network operating a mobile Internet Protocol communication that includes a coupled first gateway access router for routing communication to multiple mobile subscriber stations in a communication coverage area supported by a coupled trans-ceiver base station currently linked a first mobile subscriber station;
initiating a fast handover protocol to change connection of the first mobile subscriber station from the first Microwave Access network;
using Internet Protocol control messages integrated with Microwave Access control messages to perform the fast handover, including a fast binding update message received by the first gateway access router and a fast binding acknowledge message transmitted by the first gateway access router; and
maintaining mobile subscriber station association with a home network by updating the location of the mobile subscriber station using a binding update message transmitted from the mobile subscriber station.

21. The method for performing a fast hand-off protocol from a Microwave Access network of claim 20, further comprising the steps of:
initiating the fast handover predictively using the mobile sub-scriber station;
receiving a fast binding update message at the first gateway access router from the mobile subscriber station, said fast binding update message initiating transmission of a hand-off initiate message;
receiving a hand-off acknowledge message at the first gateway access router initiating transmission of a fast binding acknowledge message to the mobile subscriber station;
transmitting a fast neighbor advertisement message from the mobile subscriber station that initiates transmitting buffered packets addressed to the mobile subscriber station; and
completing handover to a second Microwave Access network that includes a coupled second gateway access router for routing communication to the first mobile subscriber station linked to a coupled transceiver base station.

22. The method for performing a fast hand-off protocol from a Microwave Access network of claim 20, further comprising the steps of:
initiating fast handover predictively using the first Microwave Access network;
receiving a handover directive message at the first gateway access router containing a list of recommended base stations associated with the second gateway access router for connecting to the mobile subscriber station;
receiving a fast binding update message at the first gateway access router from the mobile subscriber station, said fast binding update message initiating transmission of a hand-off initiate message;
receiving a hand-off acknowledge message at the first gateway access router initiating transmission of a fast binding acknowledge message to the mobile subscriber station;
transmitting a fast neighbor advertisement message from the mobile subscriber station that initiates transmitting buffered packets addressed to the mobile subscriber station; and
completing handover to a second Microwave Access network that includes a coupled second gateway access router for routing communication to the first mobile subscriber station linked to a coupled transceiver base station.

23. The method for performing a fast hand-off protocol from a Microwave Access network of claim 20, further comprising the steps of:
initiating fast handover reactively using the mobile subscriber station;
receiving a first fast binding update message at the first gateway access router from the mobile subscriber station that initiates transmitting information packets addressed to the mobile subscriber station to the second gateway access router for buffering;
receiving a second fast binding update message at the first gateway access router from the second gateway access router that updates routing tables to route any additional received information packets addressed to the mobile subscriber station to the new location; and
completing handover to a second Microwave Access network that includes a coupled second gateway access router for routing communication to the first mobile subscriber station linked to a coupled transceiver base station.

24. The method for performing a fast hand-off protocol from a Microwave Access network of claim 20, further comprising the steps of:
initiating fast handover reactively using the second Microwave Access network;
receiving a first fast binding update message at the first gateway access router received from the mobile subscriber station that initiates transmitting information packets addressed to the mobile subscriber station to the second gateway access router for buffering;
receiving a second fast binding update message at the first gateway access router from the second gateway access router that updates routing tables to route any additional received information addressed to the mobile subscriber station to the new location; and
completing handover to a second Microwave Access network that includes a coupled second gateway access router for routing communication to the first mobile subscriber station linked to a coupled transceiver base station.

25. The method for performing a fast hand-off protocol from a Microwave Access network of claim 20, further comprising the steps of:
transmitting a fast neighbor advertisement message encapsulating a fast binding update message from the mobile subscriber station, said fast neighbor advertisement message initiates transmitting buffered information packets addressed to the mobile subscriber station; and
completing handover to a second Microwave Access network that includes a coupled second gateway access router for routing communication to the first mobile subscriber station linked to a coupled transceiver base station.
